(19) United States
(12) Patent Application Publication
(10) Pub. No.: US 2016/0088832 A1
(43) Pub. Date: Mar. 31, 2016

(54) FORMULATIONS CONTAINING POLY (0-2 HYDROXYETHYL) STARCH FOR INCREASING THE OXYGEN-CONTENT, STABILITY AND SHELF LIFE OF AN ORGAN AND TISSUE PRESERVATION SOLUTION

(71) Applicant: SOMAHLUTION, LLC, Jupiter, FL (US)

(72) Inventors: Satish Menon, Jupiter, FL (US); Mahendra Suryan, Wellington, FL (US)

(21) Appl. No.: 14/787,480

(22) PCT Filed: Apr. 22, 2014
(86) PCT No.: PCT/US2014/034942

§ 371 Date: Oct. 28, 2015

Related U.S. Application Data
(60) Provisional application No. 61/854,708, filed on Apr. 29, 2013.

(51) Int. Cl. A01N 1/02

(52) U.S. Cl. CPC A01N 1/021

(57) ABSTRACT

Organ and tissue preservation solutions having improved formulations. The improved solutions are comprised of two separate solutions. The first solution, is comprised of one or more salts, water, dissolved oxygen, Poly (0-2-hydroxyethyl) starch, lactobionic acid, adenosine, raffinose and allopurinol and said first solution has a pH of at least 7.0;, preferably from about 7.3 to about 8.2; and a second solution comprised of water, and reduce glutathione at a pH of below 7.0, preferably from about 3 to 6 wherein oxygen present in the solution is removed. The two formulations are then mixed together at the point of use resulting in the organ and tissue preservation solution having improved stability and that contains oxygen to prevent ischemia in the preserved organs. The present invention is also comprised of kits that contain the two formulations.

The teachings of all of the references cited herein are incorporated in their entirety herein by reference.

### BACKGROUND OF THE INVENTION

University of Wisconsin cold storage solution (also known as University of Wisconsin solution or UW solution) was one of the first solutions thoughtfully designed for use in organ transplantation. UW solution and a number of similar solutions/formulations are disclosed in U.S. Pat. No. 4,879,283, U.S. Pat. No. 4,873,230 and U.S. Pat. No. 4,798,824, the disclosures of which are hereby incorporated by reference. A commercial embodiment of the UW solution has the following formulation:

| | |
|---|---|
| Poly (0-2-hydroxyethyl) starch | 50.0 grams (g)/liter (L) |
| 0.40-0.50 MS (Pentafraction) | |
| (MS = moles hydroxyethyl groups | |
| per moles anhydroglucose units) | |
| Lactobionic Acid (as Lactone) | 35.83 g/L (105 mmol/L) |
| Potassium Hydroxide 56% | 14.5 g/L (100 mmol/L) |
| Sodium Hydroxide 40% | 3.679 g/L (27 mmol/L) |
| Adenosine | 1.34 g/L (5 mmol/L) |
| Allopurinol | 0.136 g/L (1 mmol/L) |
| Potassium Dihydrogen Phosphate | 3.4 g/L (25 mmol/L) |
| Magnesium Sulphate × 7H₂O | 1.23 g/L (5 mmol/L) |
| Raffinose × 5H₂O | 17.83 g/L (30 mmol/L) |
| Reduced Glutathione | 0.922 g/L (3 mmol/L) |
| Water for Injection- Up to 1 liter | |

However, the disclosed solutions have limited stability and shelf-life due to instability of the formulation.

Thus, there is a need to produce improved formulations that are not ischemic, that contain oxygen in solution but which are at the same time stable and have a long shelf-life.

### SUMMARY OF THE INVENTION

The present invention fills this need by providing novel formulations of organ preservation solutions. The improved solutions are comprised of two separate solutions, a first solution, comprised of water, one or more salts, and hydroxyethyl starch. The solution contains dissolved oxygen, preferably saturated with oxygen and has a pH of 7.0 or above, preferably a pH from 7.3 to 8.2. The second solution is comprised of an aqueous solution containing reduced glutathione in which oxygen has been substantially removed from the solution. The second solution has a pH below 7.0, preferably a pH of 3 to 6. If the pH of the first solution is about 8.0, the pH of the second solution should be about 3.0. If the pH of the first solution is about 7.8, the pH of the second solution should be about 4.0. If the pH of the first solution is about 7.6, the pH of the second solution should be about 5.0. The two solutions, the higher pH formulation and the lower pH formulation, are then mixed together at the point of use, resulting in the organ and tissue preservation solution having improved stability. The pH of the resulting solution should be adjusted to a pH of about 7.3. The storage stability of the organ and tissue preservation solution is thus improved from weeks to many months.

In one embodiment of the present invention, the first solution is comprised of one or more salts, water, Poly (0-2-hydroxyethyl) starch, lactobionic acid, raffinose, adenosine and allopurinol. The solution has a pH of 7.0 or above, preferably a pH of from about 7.3 to 8.2 and the first solution contains dissolved oxygen, preferably saturated with oxygen. The second solution is comprised of water, and reduced glutathione at a pH below 7, preferably a pH of from about 3 to 6; and the oxygen is been substantially removed from the solution. In other words, the amount of oxygen in the solution is so low that it has no significant effect on the reduced glutathione. Generally there will be 0.1 ppm or less. Dissolved oxygen can be removed from the second solution by purging the second solution with an inert gas such as nitrogen or argon. If the pH of the first solution is about 8.0, the pH of the second solution should be about 3.0. If the pH of the first solution is about 7.8, the pH of the second solution should be about 4.0. If the pH of the first solution is about 7.6, the pH of the second solution should be about 5.0.

The most preferred embodiments are shown in the Examples below.

### BRIEF DESCRIPTION OF THE DRAWINGS

FIG. 1 is a diagrammatic depiction of the present invention; and

FIG. 2 is a diagrammatic depiction of an alternative embodiment of the present invention.

### DETAILED DESCRIPTION

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described. For purposes of the present invention, the following terms are defined below.

As used herein, the term “patient” includes members of the animal kingdom including but not limited to human beings.

As employed herein, “organ” includes, but is not limited to, the heart, veins, arteries, lungs, liver, pancreas and the kidneys. Portions of organs are also contemplated.

As used herein, “sterile water” includes, but is not limited to, (a) sterile water for injection, USP, (b) sterile distilled deionized water, and (c) sterile water for irrigation.

As used herein, “cardioplegia” includes, but is not limited to, paralysis of the heart.

As used herein, “moderate hypothermia” is about 10.degree.-21.degree. C.

As used herein, an “antioxidant” is a substance that, when present in a mixture or structure containing an oxidizable substrate biological molecule, delays or prevents oxidation of the substrate biological molecule. For example, ascorbic acid is an antioxidant.

“Balanced salt solution” is defined as an aqueous solution that is osmotically balanced to prevent acute cell or tissue damage.

“Buffered salt solution” is defined as a balanced salt solution to which chemicals have been added to maintain a predetermined physiological pH range.

“Graft” is defined as tissue that is transplanted or implanted in a part of the body to repair a defect.

“Harvested bypass conduit” is defined as a surgically installed alternate route for the blood to bypass an obstruction.

“Solution of cardioplegia” is defined as a solution that aids in the preservation of the heart during transport or surgery.

“Cellular reducing agent” is defined as a substance that loses electrons easily thereby causing other substances to be reduced chemically.

“Physiological solution” is defined as an aqueous salt solution which is compatible with normal tissue, by virtue of being isotonic with normal interstitial fluid.

According to the present invention, a cold storage solution system of the University of Wisconsin-type includes a first solution and a separate second solution, which are combined at the point of use as an organ and tissue preservation solution.

The first solution will include one or more of the following components: poly (0-2- hydroxyethyl) starch; lactobionic acid; potassium phosphate monobasic; magnesium sulphate; raffinose; pentahydrate; adenosine and allopurinol. These will be combined in a sterile water and their pH adjusted to above 7, preferably 7.3 to 8.2. This can be done with any biologically-acceptable base and, in particular, sodium hydroxide.

In particular, this first solution should include one or more salts, water, polyhydroxy salt; lactobionic acid; adenosine and allopurinol. These components are combined together and the solution adjusted to the desired pH by adding the appropriate base, such as sodium hydroxide.

The second solution, which is kept separate from the first solution, includes water, reduced glutathione and the pH is maintained below 7, preferably between about 3-6. If the pH of the first solution is about 8.0, the pH of the second solution should be about 3.0. If the pH of the first solution is about 7.8, the pH of the second solution should be about 4.0. If the pH of the first solution is about 7.6, the pH of the second solution should be about 5.0. The second solution is substantially void of dissolved oxygen. In other words, the amount of dissolved oxygen in the solution will be so low that it does not significantly negatively impact the reduced glutathione. Generally there will be 0.1 ppm or less of dissolved oxygen. This solution is formed by simply combining the desired components in water, adjusting the pH to about 7.3±0.4 with, for example, sodium hydroxide and subsequently purging the system with an inert gas, such as nitrogen or argon to drive off any dissolved oxygen.

The solutions, devices, and perfusion methods of the present invention are not limited to use with a particular tissue, organ or cell type. For example, the invention may be used with harvested saphenous veins, epigastric arteries, gastroepiploic arteries and radial arteries used in coronary bypass grafting (CABG). The present invention may also be used to maintain organs and tissue during transplant operations. The present invention is not limited to any particular tissue or organ. For example, it is contemplated that such organs or tissues may be heart, lungs, kidney, brain, muscle grafts, skin, intestine, bone, appendages, eyes, etc or portions thereof. Additionally, the present invention may be used as an in situ tissue or organ preservative. It is contemplated that the solution of the present invention be used to wash and bath tissues and organs that have not been removed from the patient. For example, it is contemplated that the present invention be used during cardioplegia. It is also contemplated that the present invention be used in, for example, emergency procedures where a tissue or organ may need to be bathed to preserve it until surgery or other medical attention can be obtained. In this regard, the solution may be made available to emergency medical personnel both in hospital settings and “in the field” (i.e., in ambulances or in temporary emergency medical facilities).

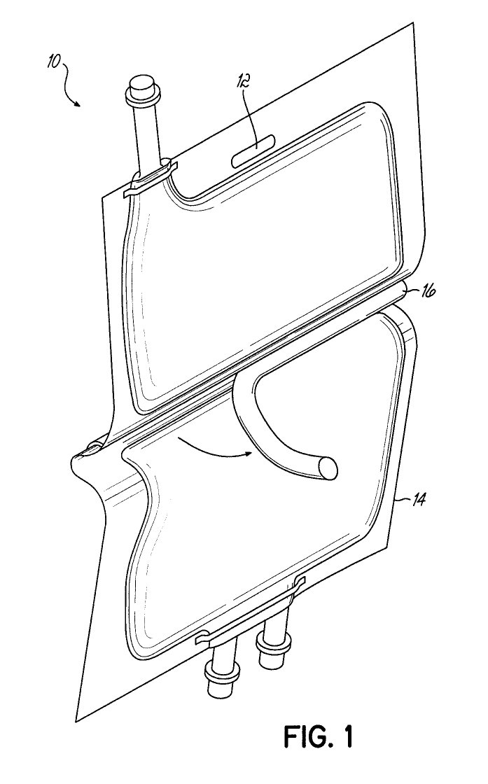

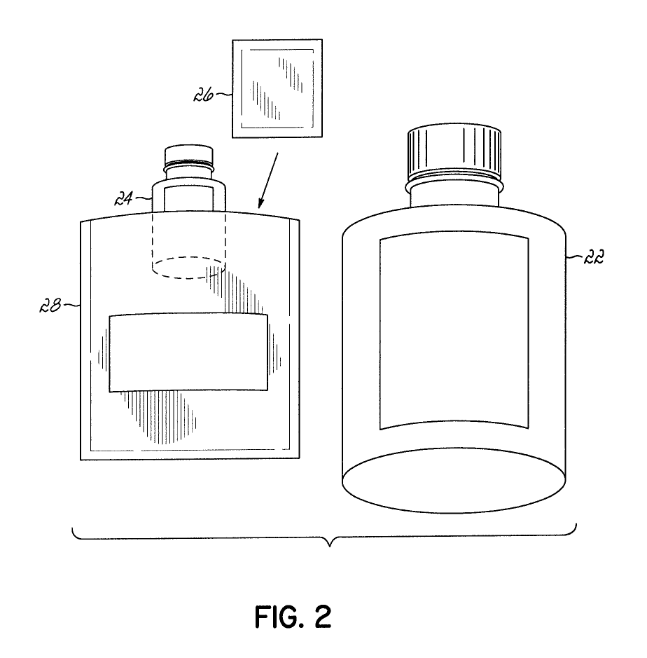

Kits can be formed according to the present invention. The first and second solutions can be placed in separate chambers of one container such as the bag shown in FIG. 1 forming a kit. Alternatively, the first and second solutions can be placed in separate containers as shown in FIG. 2.

FIG. 1 shows a bag 10 having two chambers 12 and 14 that are partitioned or clamped off from each other by clamp 16. Chamber 12 contains a first solution and chamber 14 contains a second solution. When clamp 16 is removed, chambers 12 and 14 become one chamber of bag 10 and Solution 1 mixes with solution 2 resulting in the complete organ and tissue preservation solution in bag 10. See U.S. Pat. No. 5,257,985, the disclosure of which is hereby incorporated by reference.

FIG. 2 shows an organ and tissue preservation kit 20 having two containers 22 and 24. A first solution is contained in container 22 and a second solution is contained in container 24. At the point of use, the contents of container 24 can be emptied into container 22 to produce the complete organ and tissue preservation solution.

The following examples are meant to illustrate the invention, but not limit it in any way.

### EXAMPLE 1

### Tissue Preservation Formulation having Increased Stability and Shelf Life.

### Formulation for UW solution Generic—Two container

Formula 1

| | |
|---|---|
| Component | Concentration g/L |

Solution 1

| | |
|---|---|
| Pentafraction | 50 |
| Lactobionic acid as lactone | 35.83 |
| Potassium phosphate monobasic | 3.4 |
| Magnesium Sulfate | 1.23 |
| Raffinose pentahydrate | 17.83 |
| Adenosine | 1.34 |
| Allopurinol | 0.136 |
| Potassium Hydroxide | 5.61 |
| Sodium Hydroxide/HCl | Adjust pH to 7.3-8.2 |
| Water for injection | q.s. to 950 ml |

Solution 2 in inert atmosphere

| | |
|---|---|
| Glutathione reduced | 0.922 |
| WFI | q.s. 50 ml |
| NaOH | adjust pH to 3.0-6.0 |

### EXAMPLE 2

Formula 2
Potassium replaced by Sodium potentially safer solution.

| | |
|---|---|
| Component | Concentration g/L |

Solution 1

| | |
|---|---|
| Pentafraction | 50 |
| Lactobionic acid as lactone | 35.83 |
| Sodium phosphate monobasic | 3.0 |
| Magnesium Sulfate | 1.23 |
| Raffinose pentahydrate | 17.83 |
| Adenosine | 1.34 |
| Allopurinol | 0.136 |
| Sodium Hydroxide | 4.0 |
| Sodium Hydroxide/HCl | Adjust pH to 7.3-8.3 |
| Water for injection | q.s. to 950 ml |

Solution 2 in inert atmosphere

| | |
|---|---|
| Glutathione reduced | 0.922 |
| WFI | q.s. 50 ml |
| NaOH/HCl | adjust pH to 3.0-6.0 |

### EXAMPLE 3

Formula 3
(Potassium reduced to safer levels but not eliminated)

| | |
|---|---|
| Component | Concentration g/L |

Solution 1

| | |
|---|---|
| Pentafraction | 50 |
| Lactobionic acid as lactone | 35.83 |
| Potassium phosphate monobasic | 0.68 |
| Sodium phosphate monobasic | 2.4 |
| Magnesium Sulfate heptahydrate | 1.23 |
| Raffinose pentahydrate | 17.83 |
| Adenosine | 1.34 |
| Allopurinol | 0.136 |
| Sodium Hydroxide | 4.0 |
| Sodium Hydroxide/HCl | Adjust pH to 7.3 to 8.3 |
| Water for injection | q.s. to 950 ml |

Solution 2 in inert atmosphere with
substantially all dissolve oxygen removed

| | |
|---|---|
| Glutathione reduced | 0.922 |
| WFI | q.s. 50 ml |
| NaOH/HCl | Adjust pH to 3.0-6.0 |

To use the solution of the present invention, the solution 1 is combined with solution 2, the pH of the resultant solution is adjusted to about 7.3±0.4 and immediately the tissue or organ which is being preserved is placed in the solution in a sealed container, such as a plastic bag or the like, which is then chilled by, for example, placing it in an ice bath. This will act as a storage medium of the tissue or organ, maintaining its viability for a longer period of time.

What is claimed is:

1. An organ and preservation kit comprised of a first aqueous solution contained in a first container and a second solution contained in a second container wherein the first aqueous solution is comprised of a one or more salts, water, dissolved oxygen, Poly (0-2-hydroxyethyl) starch, and at least one of lactobionic acid, adenosine, raffinose and allopurinol and said first solution has a pH of at least 7.0; wherein the second solution is comprised of water, reduced glutathione and said second solution has a pH of below 7 and the second solution contains substantially no oxygen.

2. The kit of claim 1 wherein the first and second containers are first and second chambers of a single container and the first and second chambers are separated by a removable partition, wherein upon the removal of the partition, the first solution mixes with the second solution to form the complete organ and tissue preservation solution.

3. The kit of claim 1 wherein the pH of the first solution is about from about 7.3 to about 8.2 and the pH of the second solution is from about 3 to about 6.

4. A method for preparing an organ or tissue preservation solution comprising;
combining a first solution comprising mixing water, one or more salts Poly (0-2-hydroxyethyl) starch, and at least one of lactobionic acid, adenosine, raffinose and allopurinol wherein the first solution contains dissolved oxygen and has a pH of above 7;
with a second solution comprising mixing water and glutathione together at a pH of below 7 and removing oxygen from the second solution; and at the point of use.

5. The process of claim 4 wherein the pH of the first solution is from about 7.3 to 8.3 and the pH of the second solution is from about 3 to 6.

6. A method for preserving a tissue or organ comprised of bringing the tissue or organ into contact with a solution made according to the process of claim 4.

7. The method of claim 7 wherein the tissue or organ is selected from the group consisting of saphenous veins, epigastric arteries, gastroepiploic arteries, radial arteries, heart, lungs, kidney, brain, muscle grafts, skin, intestine, bone, appendages, eyes, and portions of said tissue or organs.

8. An organ and preservation kit comprised of a first aqueous solution contained in a first container and a second solution contained in a second container wherein the first aqueous solution is comprised of a one or more salts, water, dissolved oxygen, and a hydroxyethyl starch, and said first solution has a pH of at least 7.0; and wherein the second solution is comprised of water and reduced glutathione and said second solution has a pH of below 7 and the second solution contains substantially no oxygen.

9. The organ and preservation kit of claim 8 wherein the hydroxyethyl starch is a Poly (0-2-hydroxyethyl) starch.
